(19) United States
(12) Patent Application Publication
(10) Pub. No.: US 2021/0372276 A1
(43) Pub. Date: Dec. 2, 2021

(54) FIBER OPTIC TELEMETRY SYSTEM

(71) Applicant: Halliburton Energy Services, Inc., Houston, TX (US)

(72) Inventors: David Joe Steele, Carrollton, TX (US); Li Gao, Katy, TX (US); Shilin Chen, Montgomery, TX (US); Muralidhar Seshadri, Sugar Land, TX (US); Enrique Antonio Reyes, Tomball, TX (US); David Russ Larimore, Dallas, TX (US)

(21) Appl. No.: 17/226,545

(22) Filed: Apr. 9, 2021

Related U.S. Application Data
(63) Continuation of application No. PCT/US2020/034776, filed on May 28, 2020.

(51) Int. Cl. E21B 47/135; H04B 10/25; G01V 11/00; G01V 1/46; G01V 1/52

(52) U.S. Cl. CPC E21B 47/135; H04B 10/25891; G01V 1/52; G01V 1/46; G01V 11/002

(57) ABSTRACT

This disclosure presents systems to enable downhole bi-directional communications using a long length of fiber optic cable located within or partially within the internal diameter of a set of lower pipe segments and communicatively coupled to one or more upper pipe segments that utilize pipe cable attached to the outside diameter of each of the upper pipe segments. The long length of fiber optic cable and the one or more pipe cables from the upper pipe segments allow for communication coupling between downhole tools and surface equipment and surface computing systems. In some aspects, the pipe cable attached to the upper pipe segments can be protected from wear using clamps, collars, cages, and other protectors. In some aspects, an optical signal generator and modulator, e.g., a light source, can be located downhole proximate the downhole tools, uphole proximate one of the upper pipe segments, or proximate the surface equipment.

### CROSS-REFERENCE TO RELATED APPLICATION

This application is a continuation of and claims priority to International Application Serial No. PCT/US2020/034776 filed on May 28, 2020, and entitled “FIBER OPTIC TELEMETRY SYSTEM,” which is commonly assigned with this application and incorporated herein by reference in its entirety.

### TECHNICAL FIELD

This application is directed, in general, to enabling communications downhole and, more specifically, to using fiber optic cable for communication transmission within a borehole

### BACKGROUND

In borehole operations, there is a need to enable bidirectional communications between tools located downhole and surface or near surface equipment. Conventional communication implementations can achieve a transmission rate in the hundreds of bits per second (bps), such as mud-pulse technology, or tens of thousands of bps, such as wired drill pipe technology. Fiber optic systems can achieve a significantly higher transmission rate of 1 giga bps or higher. As the number of pipe segments inserted into the borehole increases, the number of fiber optic connectors increases proportionally. Each fiber optic connector can attenuate the optical signal, lowering the effective transmission rate. A system that can reduce this optical signal attenuation would be beneficial.

### SUMMARY

In one aspect, a system is disclosed. In one embodiment the system includes: (1) a set of lower pipe segments, capable of coupling to downhole tools, (2) a lower distal end of a long length of fiber optic cable, capable of utilizing a wet connect to connect to the downhole tools, wherein the long length of fiber optic cable is positioned after the downhole tools are located below a surface, and wherein the long length of fiber optic cable is communicatively coupled to the downhole tools, (3) a set of upper pipe segments, capable of mechanically coupling the set of lower pipe segments and a surface equipment, wherein the set of upper pipe segments includes at least one upper pipe segment (4) and an upper distal end of the long length of fiber optic cable, located uphole from the lower distal end, capable of utilizing an uphole connector to communicatively connect to a pipe cable of a first upper pipe segment in the set of upper pipe segments, and wherein each upper pipe segment in the set of upper pipe segments includes a respective pipe cable communicatively coupled to neighboring pipe cables, and where a collection including each pipe cable enables a communications coupling between the long length of fiber optic cable and the surface equipment.

In a second aspect, an apparatus is disclosed. In one embodiment the apparatus includes: (1) a long length of fiber optic cable located within a borehole, (2) a downhole tool, communicatively coupled to a lower distal end of the long length of fiber optic cable, wherein the downhole tool utilizes a wet connect, (3) a set of pipe segments, where each pipe segment is mechanically coupled to a neighboring pipe segment, and wherein a first upper pipe segment in the set of pipe segments is coupled to an upper distal end of the long length of fiber optic cable, and the first upper pipe segment is located uphole from the downhole tool, and (4) surface equipment coupled to the set of pipe segments.

In a third aspect, a method is disclosed. In one embodiment, the method includes: (1) connecting a downhole tool to a set of lower pipe segments and lowering the downhole tool below a surface using the set of lower pipe segments, (2) coupling an uphole portion of the set of lower pipe segments to a first uphole pipe segment, wherein a lower distal end of a long length of fiber optic cable is lowered within an internal diameter of the set of lower pipe segments and communicatively coupled to the downhole tool, and an upper distal end of the long length of fiber optic cable coupled to the first uphole pipe segment, (3) linking an uppermost upper pipe segment in a set of upper pipe segments to a surface equipment, wherein the set of upper pipe segments includes the first uphole pipe segment and zero or more additional upper pipe segments, and wherein each upper pipe segment in the set of upper pipe segments includes a pipe cable to communicatively couple the long length of fiber optic cable with the surface equipment, and (4) enabling communications between the surface equipment and the downhole tool using the long length of fiber optic cable and the one or more pipe cables.

### BRIEF DESCRIPTION OF THE DRAWINGS

Reference is now made to the following descriptions taken in conjunction with the accompanying drawings, in which:

FIG. 1 is an illustration of a diagram of an example well system using a fiber optic communication system;

FIG. 2 is an illustration of a diagram of an example communication system in a hydraulic fracturing (HF) well system;

FIG. 3 is an illustration of a diagram of an example communication system in an offshore well system;

FIG. 4 is an illustration of a diagram of an example apparatus with a long length of fiber optic cable connected at a surface location;

FIG. 5 is an illustration of a diagram of an example apparatus with a long length of fiber optic cable connected at a location below sea level;

FIG. 6 is an illustration of a diagram of an example downhole telemetry system inclusive of electrical connections;

FIG. 7 is an illustration of a block diagram of an example fiber optic telemetry system (FOTS) with a light source located at optional points within the system; and

FIG. 8 is an illustration of a flow diagram of an example method for implementing a FOTS.

### DETAILED DESCRIPTION

When working with boreholes, i.e., wellbores, such as in the hydrocarbon production industry, there is a need to communicate uphole and downhole. Downhole tools within the borehole and borehole controllers at or near the surface need to be able to easily and quickly transmit data, telemetry, instructions, and other information. Conventionally, various solutions have been used, such as mud-pulse technology, albeit with a general limitation of approximately 120 bits per second (bps) transmission rate. This data transmission rate includes conventional data compression techniques. Electromagnetic and acoustic transmission methods also have deficiencies with their respective communication systems. Wired drill pipes can achieve a significantly higher 56,000 bps with additional cost and lower reliability.

A fiber optic cable system can achieve higher transmission rates, such as up to approximately 40 giga bps (Gbps) over several hundred kilometers and 10 Gbps over several thousand kilometers, with the actual transmission rates dependent on the technology being utilized as well as the conditions under which the transmission is occurring. A single-mode fiber optic cable can have a core diameter between 8.0 and 10.5 micrometers (μm) and a cladding diameter of 125 μm. There can be types of single-mode fiber optic cable which have been chemically or physically altered to create properties, such as dispersion-shifted fiber and nonzero dispersion-shifted fiber. Data rates can be reduced by a polarization mode dispersion and chromatic dispersion. By using optical amplifiers and dispersion-compensating devices, optical systems can increase their effective communication range to the thousands of kilometers.

Optical signals can attenuate as the signals pass through a fiber optic connector, for example, the fiber optic connectors connecting fiber optic cables at each joint in a length of drill pipe. Signal loss in fiber optic cable can be measured in decibels (dB). A loss of three dB across a link means the transmission signal at the far end is half the intensity of the transmission signal that was sent into the fiber optic cable. A six-dB loss means one quarter of the transmission signal made it through the fiber optic connector. Once too much transmission signal has been lost, the signal can be too weak to recover and the communication can become unreliable and can eventually cease to function. The transmitter power and the sensitivity of the receiver can impact how much signal loss can be absorbed by the communication system.

Multimode graded-index fibers can have, under some circumstances, three dB per kilometer (km) of attenuation (signal loss) at a wavelength of 850 nanometers (nm), and one dB/km at 1300 nm. Singlemode loses can be, for example, 0.35 dB/km at 1310 nm and 0.25 dB/km at 1550 nm. Very high quality singlemode fiber intended for long distance applications can specify a lower level of signal loss, such as 0.19 dB/km at 1550 nm. Plastic optical fiber (POF) can lose more, such as 1.0 dB/m at 650 nm. Each fiber optic cable connector can add approximately 0.6 dB of average signal loss, and each joint (splice) can add about 0.1 dB of signal loss. For each connector, a 0.3 dB loss for most adhesive/polish or fusion splice-on connectors can be utilized for estimating the performance of a communication system. The loss specification for prepolished/mechanical splice connectors or multifiber connectors can be higher. The attenuation, e.g., loss of optical transmission signal strength or power, can significantly lower the experienced bps of the communication system.

This disclosure presents a fiber optic communication system where a long length of fiber optic cable (such as conventional fiber optic cable, reinforced fiber optic cable, supported fiber optic cable, or armored fiber optic cable) can be lowered below a surface point, such as into a borehole, and connected to the downhole tools using, for example, a wet connect such as a wet-mate connector. The fiber optic cable can be tens of thousands of feet long, though various lengths can be used. This long length of fiber optic cable can maintain the high rate of transmission while minimizing the number of fiber optic cable connectors used in the system. The reduction in the number of fiber optic cable connectors used can reduce the experienced attenuation of the optical transmission signal.

The long length of fiber optic cable can be located within, or partially within, one or more pipe segments placed, lowered, or located within the borehole. These pipe segments are the lower pipe segments and the fiber optic cable can be attached, unattached, or have both capabilities in relation to the lower pipe segments. In aspects of this disclosure where the lower pipe segments are rotated, the long length of fiber optic cable, which is located inside of the internal diameter (ID) of the lower pipe segments, can rotate freely with the lower pipe segments, setting aside inertial effects.

The uphole end of the fiber optic cable can be connected to a first upper pipe segment utilizing an uphole connector. Additional upper pipe segments can be connected to the first upper pipe segment to build the length of total pipe connected to the surface equipment. The surface equipment can be, for example, a derrick, a drilling system, a computing system, a well site controller, an electrical system, a power source, or a combination thereof. Each upper pipe segment also includes a communication connector and cable/wire, such as a fiber optic connector and a fiber optic cable, or an electrical connector and electrical cable or wire allowing for the communication coupling of the long length of fiber optic cable to surface equipment. In some aspects, the first upper pipe segment can include a wireless communication system communicatively coupled to a surface transceiver. In this aspect, the upper pipe segments do not need to have fiber optic cable or electric cable or wire. In addition, this disclosure does not specify that the pipe segments be coupled using inductive coupling technology such as is utilized with wired drill pipe solutions. As used herein, coupling can include one or more of communication coupling, power coupling, and mechanically coupling.

As used herein, communications can be one-way or bi-directional. Communications can be one or more of, but not limited to, data transmissions, amplitude changes, or frequency changes. The communications can utilize optical signals, electromagnetic signals, and other types of energy transfers such as thermal energy, radiant energy, chemical energy, nuclear energy, electrical energy, motion energy, sound energy, elastic energy, or gravitational energy. In some aspects, communications, as used herein, are not limited to the transfer of information; communications can include the transfer of one or more types of energy for perform work (e.g., adjusting a valve, activating a motor, energizing another system, or other types of work) or to effect a change of state (e.g., a binary switch or variable, a position indicator, a programmed variable, a conditional variable, or other types of state changes).

The utilization of the long length of fiber optic cable in the lower pipe segments results in fewer connectors over this length. The reduction in the number of connectors along this length can result in a reduction of the impact on the transmission signal strength due to the higher hydrostatic pressure (which can be, for example, 20,000 pounds per square inch (psi) at 30,000 feet deep) and the higher bore hole temperatures at the deeper depths within the borehole. The connectors can be more sensitive to the environment factors as compared to the fiber optic cable itself. There can be more than one transmission signal transmitted through the fiber optic cable and there can be more than one fiber optic cable, or the cable can include more than one strand. The connectors (fiber optic or electrical) used with the upper pipe segments can be subject to lower hydrostatic pressure, such as 2,000 psi at 3,000 feet of depth, as well as subject to lower borehole temperatures, where the lower pressure and temperature have a reduced impact on the transmission signal.

Depending on the type of upper pipe segments employed, the pipe cable attached to each upper pipe segment, typically attached on the exterior of the outside diameter (OD) of the pipe segment, can be moved or rotated as the upper pipe segment is moved or rotated. The pipe cable can be fiber optic cable, electric cable, or electric wire. In aspects where the lower and upper pipe segments are drill pipe segments, the connected pipe segments can be rotated to allow for a rotation of a bottom hole assembly (BHA). The rotation can have the potential for an attached pipe cable to touch or rub against the borehole, casing, riser, or other borehole components. The pipe cable can experience failure due to this wearing. To protect the pipe cable, protectors can be applied to the upper pipe segments, for example, a cage. Various restraining devices can be used to hold the protector in place, and in some aspects provide protection. Casing collars, mechanical stop collars, clamps (for example, a friction clamp using set screws, a spiral pin clamp, or a tooth or dog type clamp), and various types of centralizers can be utilized as protectors or restraining devices.

Running a cable or wire on the outside of the drill pipe can increase costs and potential danger, especially in situations when the clearance between the drill sting, e.g., drill pipe, and the casing (or borehole) is minimal. In this disclosure, the clearance between the drill string and the riser can be substantial. In an example implementation, a riser can have a 19½ inches OD with an ID of approximately 18 inches.

Drill pipes utilized in deep-water wells can be typically 6⅝ inches (an OD of 6⅝ inches and a tool joint, e.g., connection, with an OD of 8½ inches. The radial gap between the tool joint OD and the riser ID can be approximately (18 inches−8½ inches)/2=9½ inches/2=4.75 inches. These component parameters allow the ability to run a centralizer or other type of device to protect the pipe cable. Preferably, the pipe cable can be pre-installed on the drill pipe segments to reduce time attaching those components on the rig floor. Likewise, the making up of three drill pipe segments into a stand of drill pipe and racking back the stands in the derrick will increase the efficiency of the operation. Then when it is time to trip-in-hole (TIH) and commence drilling, one connection every 90-feet can be made versus three connections when single joints of drill pipe are utilized.

The pipe cable protectors and pipe cable segments can be installed on the next stand while drilling utilizing the previous stand section. For example, while drilling from 12,997 feet to 19,500 feet, well site operators can make-up 3-30-foot joints of drill pipe to make a 90-foot-tall stand. They would rack it back into the derrick while the drilling is ongoing. Since the next hole section can be 4,457 feet long, they would rack back 51 stands of drill pipe. In the process of making up the 3-30-foot joints, users can install the pipe cable protectors and the pipe cable segments while not interrupting the drilling operations. The pipe cable segments can be 90 feet long, e.g., the length of the stand, or 30 feet long, e.g., three would be installed per stand. Other pipe cable lengths can be installed as well. By installing a pipe cable the length of a stand of drill pipe, the number of connectors used can be reduced as compared to using a pipe cable the length of each drill pipe segment—in this example, the number of connectors can be reduced by two-thirds.

Two pipe cable protectors can be installed on each stand. In some aspects, two or more clamps, or other attachment devices, can be added to secure the line to the tube of the drill pipe. In some aspects, two clamps per joint can be utilized. The ends of each pipe cable can be secured to ensure (1) the ends would remain protected during the installation and rack-back procedure, (2) could be secured to the drill pipe when rack-backed, (3) would not interfere with the use of regular drilling equipment, e.g., iron roughneck, elevators and slips while TIH, (4) could be connected relatively quickly while TIH, and (5) to ensure a communicatively clean connection when connected.

A light source to generate the optical signal can be located downhole proximate the downhole wet-mate connector, uphole of where the long length of fiber optic cable (or multiple cables) connects to the first upper pipe segment, in another part of the upper pipe segments, or at a surface location. The light source can be one or more of a laser (including a laser emitting diode), a light emitting diode (LED), a high-powered LED, and other conventional light sources used for producing or modulating an optical signal along a fiber optic cable. In some aspects, the light source can be replaced by a different energy source using wavelengths along the electromagnetic spectrum that are longer or shorter than the visible light spectrum.

In aspects where the light source is located proximate the wet-mate connector and downhole tools, the light source can be powered by an energy source located within the downhole tools, such as one or more batteries, capacitors, generators, and other energy sources. In some aspects, the light source can be powered by a separate electrical cable or electrical wire that is installed parallel to the long length of fiber optic cable where the uphole end of the electrical cable or electrical wire is electrically coupled to surface equipment, such as using connectors and cable or wire segments on each upper pipe segment. In some aspects, the upper pipe segment pipe cables can be electrical wires or cables and be utilized to deliver electrical energy downhole and be utilized to communicatively connect the long length of fiber optic cable to surface equipment.

The downhole tools can communicate with the light source to send communications, such as telemetry data, through the long length of fiber optic cable and electrical wires or cables to the surface equipment. The downhole end of the long length of fiber optic cable can also be mated with electro-optical devices that can transform the optical signal to an electrical signal and vice versa, as well as circuitry or software to perform signal processing, data manipulation, such as applying compression, and modulation algorithms. The resultant electrical signal can allow the downhole tools to receive data and instructions from the surface equipment.

In aspects where the light source is located proximate the first upper pipe segment, a light source receptor, a reflector, a receiver, a transceiver, a demodulator, a modulator, an amplifier, a converter or an energy device can be utilized proximate the downhole wet-mate connector to enable optical signal reception, modulation, conversion, or demodulation thereby providing a mechanism for the downhole tools to transceive data, information, and instructions with the surface equipment. In this aspect, the light source can avoid the higher hydrostatic pressures and temperatures downhole, as well as avoiding vibration effects from the use of the downhole tools, for example, vibrations from a BHA. The light source can be powered by surface equipment or an energy source located proximate the light source. In some aspects, the light source can be a second light source. In some aspects, the light source can include transceiver capabilities, for example, to transmit and receive light signals. In other aspects, the receiving and the transmitting may be performed by separate devices, where the devices can be shared, partially shared, functionally partially shared, physically partially shared, or a combination thereof.

In some aspects, the light source can be located proximate surface equipment. In this aspect, the upper pipe segments include attached fiber optic cable portions where the fiber optic cable attached to the first upper pipe segment is coupled to the long length of fiber optic cable. A light source receptor and reflector device can be utilized proximate the downhole wet-mate connector to enable optical signal modulation thereby providing a mechanism for the downhole tools to transceive data, information, and instructions with the surface equipment. The light source can be powered by surface equipment or an energy source located proximate the light source. In one or more of the above described aspects, there can be more than one light sources utilized, for example, one light source located proximate the BHA and one light source located proximate the first upper pipe segment, or one light source located proximate the surface equipment.

This disclosure can be utilized in various applications, such as hydrocarbon and non-hydrocarbon drilling systems, drill stem tests, formation tests, and hydrocarbon production systems, such as completion systems, workovers, evaluation systems, production systems, hydraulic fracturing (HF) systems, on and off shore systems, and intelligent completion systems. The higher transceived signal bandwidth and transmission rate that is enabled can facilitate the use of tools and systems, such as seismic while drilling (SWD) tools, data collection tools, drilling tools, logging while drilling tools, measuring while drilling tools, valves, actuators, and wireline tools. In addition, alternative communication systems can be replaced with the described fiber optic cable system, such as replacing wireless communication systems.

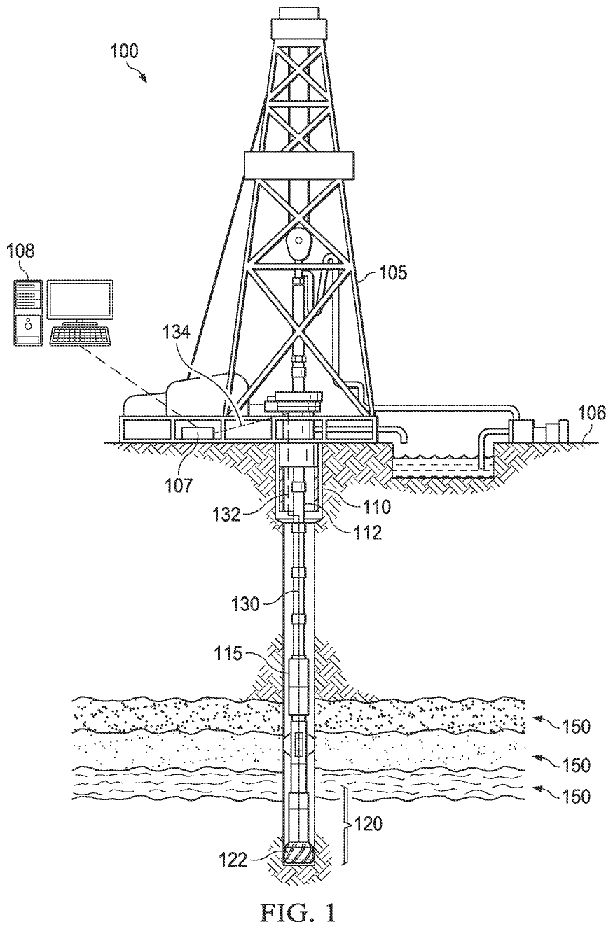

Turning now to the figures, FIG. 1 is an illustration of a diagram of an example well system 100 using a fiber optic communication system, for example, a drilling system, a logging while drilling (LWD) system, a measuring while drilling (MWD) system, a SWD system, a telemetry while drilling system, an extraction system, a formation evaluation system, a fluids evaluation system, a production system, a wireline system with a pump, and other hydrocarbon well systems. Well system 100 includes a derrick 105, a well site controller 107, and a computing system 108. Well site controller 107 includes a processor and a memory and is configured to direct operation of well system 100. Derrick 105 is located at a surface 106.

Extending below derrick 105 is a borehole 110, with a set of upper pipe segments 112 and a set of lower pipe segments 115 located within the diameter of borehole 110. Located at the bottom of set of lower pipe segments 115 are downhole tools 120. Downhole tools 120 can include various downhole tools and BHA, such as drilling bit 122. Other components of downhole tools 120 can be present, such as a local power supply (e.g., a generator), batteries, capacitors, telemetry systems, sensors, transceivers, and a control system. Borehole 110 is surrounded by subterranean formation 150.

Inserted into set of lower pipe segments 115 is a long length of fiber optic cable 130 (shown as a solid line). Long length of fiber optic cable 130 is coupled to downhole tools 120 using a wet-mate connector. The uphole end of long length of fiber optic cable 130 is connected to the lowermost, e.g., first, upper pipe segment in set of upper pipe segments 112. A protected pipe cable 132 (shown as a dashed line) is attached to the outside of set of upper pipe segments 112. Protected pipe cable 132 extends to derrick 105 and is coupled to one or more electrical cables 134 (shown as a dotted line) coupling to well site controller 107. Protected pipe cable 132 can be protected from rotational wear alongside the riser, casing, or drill pipe by being attached to the respective upper pipe segment using a centralizer, clamp, cage, other protectors, or various combinations thereof. Protected pipe cable 132 can be one or more cables and wires (such as fiber optic cables, electric cables, electric wires, or a combination thereof), and be of various lengths, such as 30-foot-long portions for drill pipe segments or 90-foot-long portions for drill pipe stands.

In some aspects, electrical cables 134 can be replaced with a wireless transceiver communication system. In some aspects, the connection coupling between protected pipe cable 132 and the well site controller 107 can utilize a slip-ring type of connector. In some aspects, protected pipe cable 132 can end prior to coupling with equipment at derrick 105, and an electrical connection, a fiber optic connection, or a wireless connection can be utilized to couple protected pipe cable 132 and well site controller 107.

Well site controller 107 or computing system 108 which can be communicatively coupled to well site controller 107 or protected pipe cable 132, or, can be utilized to communicate with downhole tools 120, such as sending and receiving telemetry, data, instructions, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the process and methods described herein. Well site operators, engineers, and other personnel can send and receive the telemetry, data, instructions, and other information by various conventional means with computing system 108 or well site controller 107.

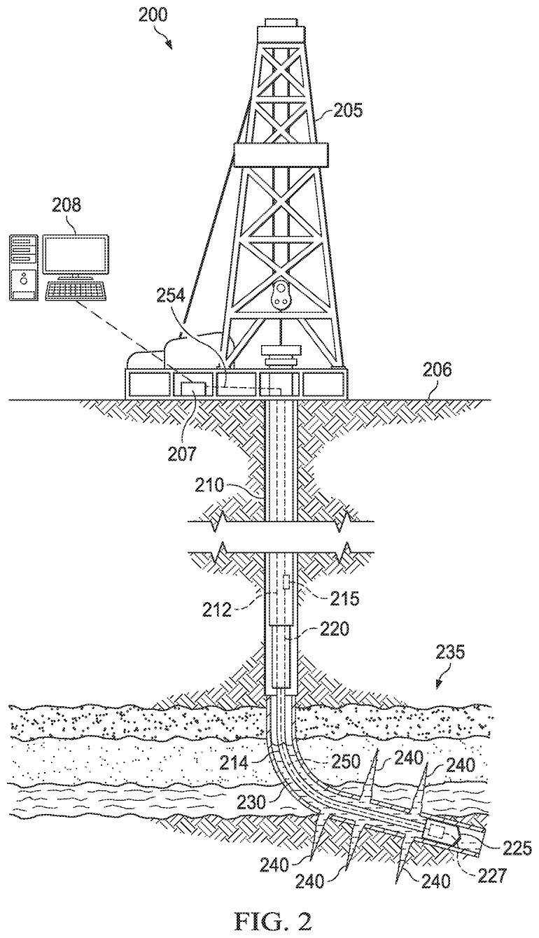

FIG. 2 is an illustration of a diagram of an example communication system in a HF well system 200, which can be a well site where HF operations are occurring through the implementation of a HF treatment plan. HF well system 200 demonstrates a nearly horizontal borehole undergoing a fracturing operation.

HF well system 200 includes surface well equipment 205 located at a surface 206, well site control equipment 207, a fiber optic light source 215 located below surface 206, and a computing system 208. In some aspects, well site control equipment 207 is communicatively connected to separate computing system 208, for example, a server, data center, cloud service, tablet, laptop, smartphone, or other types of computing systems. Computing system 208 can be located proximate to well site control equipment 207 or located a distance from well site control equipment 207, and can be utilized by a well system engineer and operator to transceive telemetry, data, instructions, and other information.

Extending below surface 206 from surface well equipment 205 is a borehole 210. Borehole 210 can have zero or more cased sections and a bottom section that is cased or uncased. Inserted into borehole 210 is a fluid pipe 220. The bottom portion of fluid pipe 220 has the capability of releasing downhole material 230, such as carrier fluid with diverter material, from fluid pipe 220 to subterranean formations 235 containing fractures 240. The release of downhole material 230 can be by sliding sleeves, valves, perforations in fluid pipe 220, or by other release means. At the end of fluid pipe 220 is an end of pipe assembly 225, which can include one or more downhole tools or an end cap assembly. In some aspects where fiber optic light source 215 is not present, end of pipe assembly 225 can include a downhole light source 227 to enable transmission signal production and modulation for generating communications between end of pipe assembly 225 and well site control equipment 207 and computing system 208.

Upper pipe segments 212 of fluid pipe 220 includes fiber optic cable coupling at each upper pipe segment joint or at each upper pipe stand segment joint. In addition, fiber optic light source 215 is located downhole at a coupling joint of upper pipe segments 212, such as at the first upper pipe segment. The fiber optic cable of upper pipe segments 212 is coupled to surface fiber optic cable 254 (shown as a dashed line) which in turn is coupled to well site control equipment 207 and computing system 208. Similar to well system 100, in some aspects, the upper pipe segments 212 can utilize electrical cables or wires in place of fiber optic cables. In some aspects, the fiber optic cables attached to upper pipe segments 212 or the electrical cables attached to upper pipe segments 212 can be communicatively coupled to well site control equipment 207 using a slip-ring connector or a wireless transceiver system.

A long length of fiber optic cable 250 is located in lower pipe segments 214 of fluid pipe 220 and is coupled to the fiber optic cable of upper pipe segments 212 and end of pipe assembly 225. In other aspects, long length of fiber optic cable 250 can be located exterior to lower pipe segments 214. In some aspects, when downhole light source 227 is present, long length of fiber optic cable 250 is coupled to downhole light source 227. Tools of end of pipe assembly 225 and well site control equipment 207 can utilize the one or more of fiber optic light source 215 and downhole light source 227, along with receiver or transceiver capabilities or devices, to generate communications with the other of end of pipe assembly 225 or well site control equipment 207. In addition, long length of fiber optic cable 250 can be utilized as a sensor, such as a distributed acoustic sensor, throughout its length. In some aspects, end of pipe assembly 225 can be located at various depths within borehole 210 in addition to the end of pipe location.

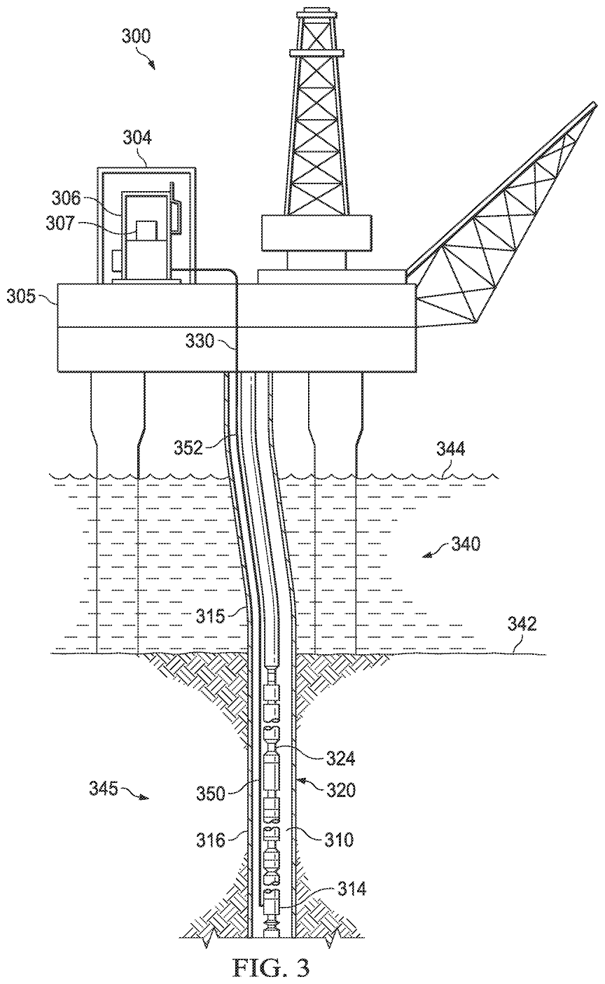

FIG. 3 is an illustration of a diagram of an example communication system in an offshore well system 300, where an electric submersible pump (ESP) assembly 320 is placed downhole in a borehole 310 below a body of water 340, such as an ocean or sea. Borehole 310, protected by casing, screens, or other structures, is surrounded by subterranean formation 345. ESP assembly 320 can also be used for onshore operations. ESP assembly 320 includes a well controller 307 (for example, to act as a speed and communications controller of ESP assembly 320), an ESP motor 314, and an ESP pump 324.

Well controller 307 is placed in a cabinet 306 inside a control room 304 on an offshore platform 305, such as an oil rig. Well controller 307 is configured to adjust the operations of ESP motor 314 to improve well productivity. In the illustrated aspect, ESP motor 314 is a two-pole, three-phase squirrel cage induction motor that operates to turn ESP pump 324. ESP motor 314 is located near the bottom of ESP assembly 320, just above downhole sensors within borehole 310. A power cable 330 extends from well controller 307 to ESP motor 314.

In some aspects, ESP pump 324 can be a horizontal surface pump, a progressive cavity pump, a subsurface compressor system, or an electric submersible progressive cavity pump. A motor seal section and intake section may extend between ESP motor 314 and ESP pump 324. A riser 315 separates ESP assembly 320 from water 340, and a casing 316 can separate borehole 310 from subterranean formation 345. Perforations in casing 316 can allow the fluid of interest from subterranean formation 345 to enter borehole 310.

Parallel to power cable 330, is long length of fiber optic cable 350 and upper pipe segment fiber optic cable 352 (in this figure, power cable 330, long length of fiber of optic cable 350, and upper pipe segment fiber optic cable 352 appear as a thick line representing both power cable 330 and the respective long length of fiber optic cable 350 and upper pipe segment fiber optic cable 352, and in other aspects, can be located exterior to the ESP tubing). A fiber optic light source can be located downhole, such as proximate ESP motor 314 located within riser 315 at subterranean surface 342 or at water surface 344, at offshore platform 305, or at another depth within borehole 310. Power cable 330 can provide energy to a downhole fiber optic light source.

FIGS. 1 and 2 depict onshore operations. Those skilled in the art will understand that the disclosure is equally well suited for use in offshore operations. FIGS. 1, 2, and 3 depict specific borehole configurations, those skilled in the art will understand that the disclosure is equally well suited for use in boreholes having other orientations including vertical boreholes, horizontal boreholes, slanted boreholes, multilateral boreholes, and other borehole types.

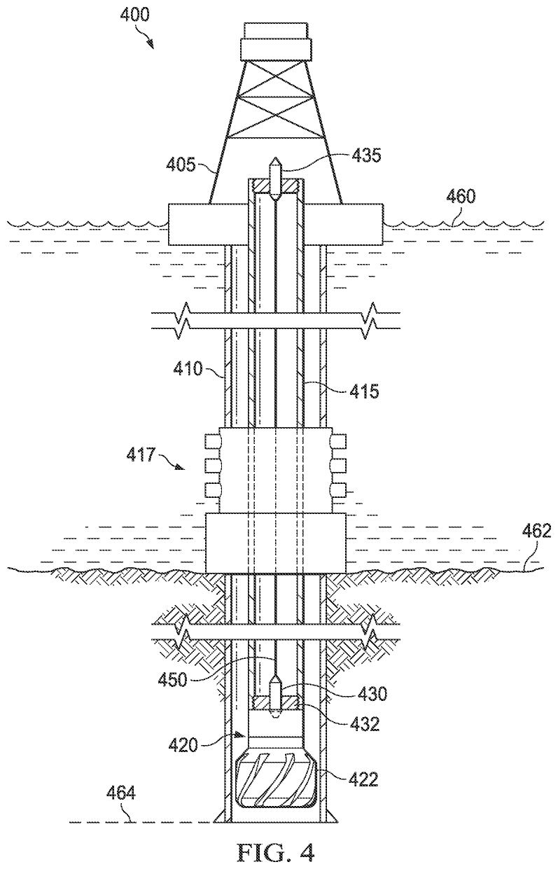

FIG. 4 is an illustration of a diagram of an example apparatus 400 with a long length of fiber optic cable connected at a surface location. Apparatus 400 is shown in an offshore operation. The disclosed systems can be utilized in on-shore and other operating environments. Apparatus 400 can be utilized to provide high bandwidth communications between downhole tools and surface equipment. Apparatus 400 includes surface equipment 405, a drill riser 410, a drill string 415 located inside drill riser 410, and a BHA 420. BHA 420 can be various types of downhole tools, drill bits, sensors, fluid controls, energy sources, transceivers, and combinations thereof.

BHA 420 can further include a drilling assembly 422. Inserted into drill string 415 is a long length of fiber optic cable 450, located in the lower portion of drill string 415. Long length of fiber optic cable 450 is at least the length of three stands and can be tens of thousands of feet long. A lower distal end of long length of fiber optic cable 450 is coupled to BHA 420 using a fiber optic cable connector 430 and a BHA wet connect 432. Proximate fiber optic cable connector 430 can be a downhole light source, if present. The downhole light source can have the capability to be a receiver, transmitter, or transceiver. An upper distal end of long length of fiber optic cable 450 is coupled uphole to surface equipment 405 utilizing uphole connector 435.

Surface equipment 405 is, preferably, located at or above sea level 460. Above sea floor 462 are blow out protectors 417. Drilling assembly 422 is located proximate a bottomhole 464 of the borehole. For demonstration purposes, in this example, bottomhole 464 can be at 23,000 feet below sea level 460. Sea floor 462 can be 7,000 feet below sea level 460. Long length of fiber optic cable 450 can extend from BHA 420 to uphole connector 435, approximately 23,000 feet. The 23,000 feet of long length of fiber optic cable 450 can reduce the number of connectors used in the system thereby reducing the attenuation of the fiber optic signal.

The remaining distance to surface equipment 405 can utilize upper pipe segments with fiber optic cables, or electrical cables or wires. Utilizing fiber optic cable portions, one for each pipe segment, can result in signal loss. Utilizing electrical cables on the upper pipe segments can reduce this potential signal loss. In some aspects where fiber optic cables ae utilized, fiber optic amplifiers can be utilized to reduce the potential signal loss. Optionally, the upper pipe segments can include protectors, such as cages, clamps, centralizers, and collars, to protect the fiber optic cable from rotational wear—the protectors can rotate in tandem with the set of upper pipe segments.

The reduction in connectors can vary as the drilling depth interval changes. For example, in aspects where the drilling interval is 3,000 feet, e.g., between 23,000 and 26,000 feet, the number of connectors can be reduced to a range of approximately 33 to 100 fiber optic connections, e.g., reducing the potential signal loss to 20 to 60 dB (33*0.6 db/connector to 100*0.6 db/connector). A wired drill pipe, by comparison, would need approximately 866 inductive couplers (using conventional pipe segments) for the same 26,000-foot length. For a drilling interval of about 2,000 feet, e.g., between 26,000 and 28,000 feet, the number of fiber optic cable connectors is in a range of approximately 22 to 66, while the wired drill pipe would utilize approximately 933 inductive couplers to reach a depth of 28,000 feet.

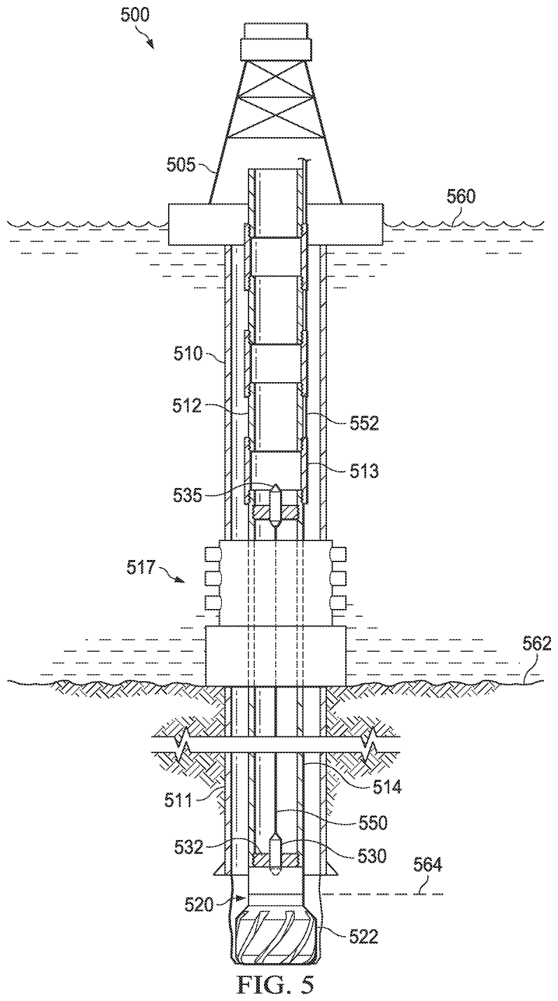

FIG. 5 is an illustration of a diagram of an example apparatus 500 with a long length of fiber optic cable connected at location below sea level. Apparatus 500 is an extension of FIG. 4 after additional borehole depth has been drilled. Apparatus 400 and apparatus 500 also demonstrate a system for high speed telemetry. Apparatus 500 is shown as an offshore operation. The disclosed systems can be utilized in on-shore and other operating environments. Apparatus 500 can be utilized to provide high bandwidth communications between downhole tools and surface equipment. Apparatus 500 includes surface equipment 505, a riser 510, a set of upper pipe segments 512 located inside the ID of riser 510, a set of lower pipe segments 514 located inside the ID of riser 510 (when above a sea floor 562) and a casing 511 (when at or below sea floor 562).

Inserted into set of lower pipe segments 514 is a long length of fiber optic cable 550. A lower distal end of long length of fiber optic cable 550 is coupled to BHA 520 using a fiber optic cable connector 530 and a BHA wet connect 532. In some aspects, fiber optic cable connector 530 and BHA wet connect 532 can include electrical coupling connectors, e.g., contacts. The electrical coupling contacts can be utilized to convert a signal transmitted through long length of fiber optic cable 550 to an electrical signal, to convert an electrical signal from BHA 520 to an optical signal, or to couple an electrical cable or wire along the length of long length of fiber optic cable 550 to BHA 520.

This process can use various combinations of transceivers, electro-optical converters, modulators, demodulators, multiplexers, demultiplexers, amplifiers, filters, and other devices to facilitate the communication coupling. In other aspects, a separate connector can be present for the electrical coupling. A downhole light source, e.g., configured as a transceiver system, can be proximate fiber optic cable connector 530. An upper distal end of long length of fiber optic cable 550 is coupled uphole to a first upper pipe segment 513 in the set of upper pipe segments 512 using uphole connector 535. In turn, each upper pipe segment in set of upper pipe segments 512 is coupled to a neighbor pipe segment (or pipe stand). The uppermost of the upper pipe segments is coupled to surface equipment 505. In some aspects, uphole connector 535 can include a fiber optic light source, e.g., also configured as a transceiver system, to produce and modulate optical signals. In other aspects, uphole connector 535 can communicatively couple to a wireless transceiver, which in turn can be coupled to surface equipment 505. Uphole connector 535 can include an electro-optical connector or an optical-optical connector.

Surface equipment 505 is located approximately at sea level 560. Above sea floor 562 are blow out protectors 517. A drilling assembly 522 is located proximate a previous bottomhole designation 564 of the borehole, and in this example, drilling assembly 522 is extending the borehole below the previous depth as indicated by previous bottomhole designation 564. For demonstration purposes, in this example, previous bottomhole designation 564 can be at 23,000 feet below sea level 560. Sea floor 562 can be 7,000 feet below sea level 560. Long length of fiber optic cable 550 can extend from BHA 520 to uphole connector 535, approximately 20,000 feet.

The remaining 3,000 feet to surface equipment 505 can utilize set of upper pipe segments 512 with pipe cables 552, such as one for each drill pipe segment (approximately 30 feet), one for each drill pipe stand (approximately 90 feet), other lengths, or a combination thereof. This can reduce the number of connectors used in the system thereby reducing the attenuation of the transmission signal. In this example, set of upper pipe segments 512 have their respective pipe cables 552 attached to the OD of the respective upper pipe segment. In some aspects, the pipe cables 552 can include protectors, such as cages, clamps, centralizers, sealing end caps, and collars, to protect pipe cables 552 from rotational wear, and can rotate in tandem with the upper pipe segments.

First upper pipe segment 513 can vary in structure from the other pipe segments in set of upper pipe segments 512, for example, its length can be 10 feet long and the OD can be larger than the other pipe segments. In some aspects, first upper pipe segment 513 can include other equipment, for example, an electro-optical connector, also known as a fiber media converter, (to connect a fiber optic cable and an electrical cable or wire, as well as convert light signals and electrical signals to the other signal type), a power source, a power regulator, a light source, such as a LED, laser, semiconductor diode laser, or another source of electromagnetic radiation. In some aspects, there can be more than one fiber optic cable, more than one electrical cable or wire, or a combination thereof and one or more signal multiplexers and one or more signal demultiplexers can be present with signal processors.

In some aspects, pipe cables 552 can be one or more fiber optic cables, one or more electrical cables, one or more electrical wires, various combinations of bundled and non-bundled cables, or various combinations thereof. Using electrical wire or cable as the pipe cable can reduce the experienced signal attenuation since the optical transmission signal would pass through fewer connectors. In some aspects, pipe cables 552 can be replaced with one or more wireless transceiver systems. In other aspects, pipe cables 552 can utilize electrical cable or wire for a portion of its length, and utilize a wireless transceiver for the remaining portion of its length.

Pipe cables 552 may be similar to commercial downhole fiber optic cables such as traditional downhole cable, hybrid downhole cable, or fiber-optic-component-umbilical-cable. Pipe cables 552 may comprise hermetic stainless-steel tube, high strength wire, polyethylene jacketed, hydrogen scavenging gel, and in-line splice technology. Pipe cables 552 can utilize insulated 18AWG copper conductor, loose tube design for optical fibers, and materials to provide protection from severe chemical environments containing H₂S, CO₂, methane, oil, diesel, gasoline, toluene, and other organic solvents. Pipe cables 552 can have a wide operating temperature range from −40.0° Celsius to 150.0° Celsius and utilize highly abrasion and impact resistant materials.

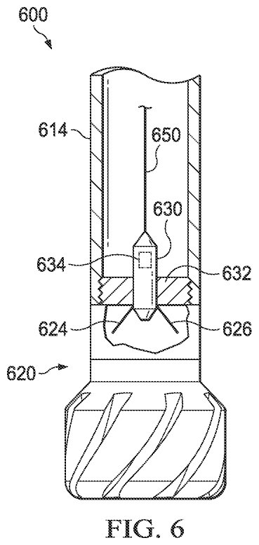

FIG. 6 is an illustration of a diagram of an example downhole telemetry system 600 inclusive of electrical connections. Downhole telemetry system 600 demonstrates the use of electrical connections with the downhole tools to provide communications with the downhole tools and to provide an energy source for the downhole light source, if present. Downhole telemetry system 600 includes a set of lower pipe segments 614 ending at downhole tools 620. Located internal of the ID of set of lower pipe segments 614 is a long length of fiber optic cable 650. Long length of fiber optic cable 650 includes connectors at the downhole end and the uphole end, minimizing connectors along its length.

It is preferred that long length of fiber optic cable 650 be an uninterrupted length. In some aspects, long length of fiber optic cable 650 can include at locations along its length splices and amplifiers, such as electrical or fiber optic-erbium doped amplifiers. In addition, long length of fiber optic cable 650 can include one or more optical strands, one or more fiber optic cables, zero or more electrical cables or wires, and support structures, such as steel strands or other materials to aid in supporting the fiber optic cable. In addition, long length of fiber optic cable 650 can have various types and combinations of cladding and protection, such as armored fiber optic cable.

At the downhole end of long length of fiber optic cable 650 is a wet connect 630. Wet connect 630 can include a light source controller, modulator, light detector, light reflector, such as a mirror to reflect a modulated signal, a power source, a power regulator, and other components used to complete the communication system. The communication system can include additional communication systems and methods, for example, a drill string communication system that can send a signal using lower pipe segments 614. In some aspects, the communication system can include components to transform communication signals. For example, components can be included that can perform signal processing to transform a signal from electric to mechanical, electric to light, light to thermal to electric, light to light, carrier wave to carrier wave, utilize signal encryption, utilize signal compression, other conversions and transformations, and various combinations thereof. In some aspects, the communication system can utilize a light source with the fiber optic cable, a light fidelity (LiFi) wireless communication system, a visible light communication (VLC) system, and other communication systems types.

In some aspects, wet connect 630 can include a light source 634, such as a laser, a high-powered LED, or other types of light or electromagnetic sources. Wet connect 630 can be coupled to downhole wet connect 632, such as a wet-mate connector, where downhole wet connect 632 is further coupled with downhole tools 620.

Electrical connection 624 can provide a communications coupling between downhole tools 620 and its respective telemetry devices (not shown), and wet connect 630. Telemetry devices can be one or more devices that can collect data downhole using various types of sensors and generate data utilizing the collected data. For example, temperature sensors, pressure sensors, magnetic resonance sensors, fluid sensors, seismic sensors, permeability and porosity sensors, and other sensor types that can be located downhole. These telemetry sensors can be used with drilling wellbores, LWD, MWD, SWD, ESP, HF, production wellbores, intercept wellbores, relief wellbores, and other types of well systems. Long length of fiber optic cable 650 can be coupled to surface equipment or to a first upper pipe segment. The first upper pipe segment can be coupled to additional upper pipe segments and, in turn, coupled to the surface equipment.

Electrical connections 626 can provide energy to wet connect 630 and, if present, light source 634. Downhole tools 620 can include a power source, such as a generator, batteries, capacitors, and other types of energy sources. This energy can be provided for use by other components such as wet connect 630. In an alternative aspect, a separate electrical wire or electrical cable can be proximate the length of long length of fiber optic cable 650. The electrical wire or electrical cable can provide a conduit for energy to be sourced uphole, such as from a surface generator or a generator position proximate downhole tools 620, and to be used by downhole tools 620, wet connect 630, and light source 634.

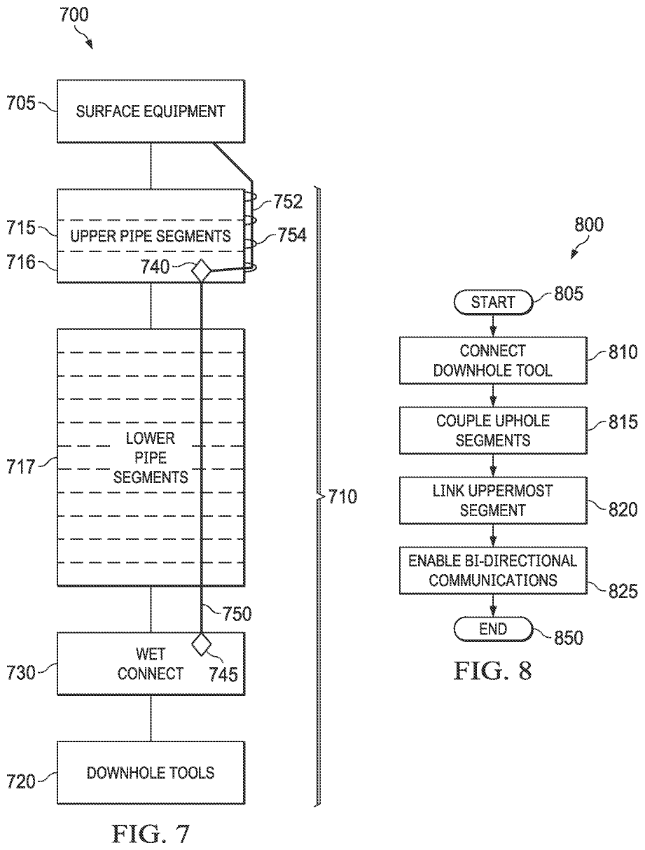

FIG. 7 is an illustration of a block diagram of an example fiber optic telemetry system (FOTS) 700 with a light source located at optional points within the system. FOTS 700 describes the groups of tools, devices, and equipment that can be mechanically or communicatively coupled in a borehole environment. FOTS 700 includes surface equipment 705, a set of upper pipe segments 715, a first upper pipe segment 716 in the set of upper pipe segments 715, a set of lower pipe segments 717, a wet connect 730, and downhole tools 720.

Surface equipment 705 can include drilling equipment, derricks, cranes, winches, controllers, pumps, pipes, computing systems, and other types of equipment used for operating the borehole system. Typically, a borehole operator or engineer, e.g., a user, at the surface can review and analyze data received from downhole tools 720 and then make adjustments to the operating plans. In addition, the user can communicate with downhole tools 720 to make changes in the instructions or operating plan in near real-time.

Alternatively, the received data can be analyzed by a computing system and adjustments made programmatically to the instructions and operating plans of downhole tools 720, for example, when a machine learning algorithm is utilized to process the received telemetry. In some aspects, a user can provide review and approval of the changes recommended by the machine learning algorithm. The computing system running the machine learning algorithm can be located downhole proximate downhole tools 720, proximate surface equipment 705, proximate first upper pipe segment 716, or at another location along the borehole length. The boreholes can be for science purposes, hydrocarbon exploration and extraction purposes, and for other purposes, for example, mineral, coal, or sulfur extraction.

Set of upper pipe segments 715 can be one or more pipe segments that include a pipe cable and connector, such as an electrical cable or wire, a fiber optic cable, a wireless transceiver system, or combination thereof, allowing a communication coupling between downhole tools 720 and surface equipment 705. First upper pipe segment 716 can include an electro-optical connector to connect a long length of fiber optic cable 750 to an additional portion of fiber optic cable, an electrical cable or wire, a wireless transceiver, or other communication tools, such as a light source, a multiplexer, a demultiplexer, a signal processor, an amplifier, and other devices. Long length of fiber optic cable 750 is at least the length of three stands and can be tens of thousands of feet long. In this example, three upper pipe segments (representing one pipe stand) are shown mechanically and communicatively coupled, separated by the dashed line, though fewer or additional pipe segments and pipe stands can be used.

In aspects where a separate electrical cable or electrical wire is included (either as a separate cable or as an electrical cable within a hybrid cable); the upper pipe segments are also electrically coupled. Pipe cable 752 can be attached to each of the upper pipe segments using conventional techniques, such as protectors 754. For example, protectors 754 can be cages, clamps, collars, and other protective and attachment devices. Pipe cable 752 can be located within protectors 754. In other aspects, protector 754 can be included within the various pipe cable 752 segments. Minimizing the number of upper pipe segments in set of upper pipe segments 715 can minimize the number of connectors in use thereby reducing the potential attenuation and transmission signal loss as the transmission signal passes through each respective connector. In addition, the reduction in upper pipe segments can reduce the need for additional protectors 754 for pipe cable 752, thereby reducing costs and potential failure points.

In some aspects, first upper pipe segment 716 can be the lowermost, middle, or another upper pipe segment and can include a light source 740. Light source 740 can be capable of producing and modulating a light source to generate an optical signal for transmission through the various fiber optic cable components. Light source 740 also includes other tools, devices, and electronics for implementing the transmission of one or more signals, such as one or more of a light detector, a light reflector, an electro-optical transform circuitry, a controller circuitry, an electrical amplifier, a light amplifier, an erbium-doped fiber amplifier, a signal processor, a modulator, a multiplexer, a demultiplexer, an energy source or an input from an energy source, and other components. In some aspects, light source 740 includes tools, devices, and electronics for implementing the reception of one or more signals, such as one or more of a light detector, a light reflector, an electro-optical transform circuitry, a controller circuitry, an electrical amplifier, a light amplifier, an erbium-doped fiber amplifier, a signal processor, a modulator, a demodulator, a multiplexer, a demultiplexer, an energy source or an input from an energy source, and other components.

Light source 740 can also be located with surface equipment 705. It also includes devices capable of receiving and transmitting optical and electrical signals, multiplexing and demultiplexing, amplifying, filtering, storing, buffering, triggering and other capabilities typically related to fiber media converters, for example, simple converters, switching converters, network bridges, managed converters, transceivers, gigabit interface converters, fiber-optic communications, small form-factor pluggable transceivers or other types of converters known within the art of data and power transfer and communications.

The data and power may be transferred using data communication protocols including, but not limited to, Ethernet, fast Ethernet, gigabit Ethernet, T1/E1/J1, DS3/E3, as well as multiple cabling types such as coax, twisted pair, multi-mode, and single-mode fiber optics, or other types of data transfer and power transfer protocols known within the art.

Set of lower pipe segments 717 can be of various shapes and sizes, and do not need to be uniform. In addition, set of lower pipe segments 717 can perform other functions than what is described herein. For example, set of lower pipe segments 717 can include, but are not limited to, drilling jars, data sensors and loggers, seismic sources, seismic receivers, other types of receivers (such as gamma ray, radioactive, geological receivers), amplifiers, flow splitters, mud coolers, formation evaluation tools, sample catches, other tools and devices, and various combinations thereof. Set of lower pipe segments 717 can have fiber optic cables and electric cables or wires, which are not utilized by the disclosure. Typically, less expensive pipe segments can be used that do not include those components.

There can be various quantities of pipe segments in set of lower pipe segments 717, and an example is shown using dashed lines to indicate a series of mechanically coupled pipe segments. FOTS 700 is not to scale and the size and quantity of upper pipe segments and lower pipe segments can vary according to the operational specifications. Set of lower pipe segments 717 can extend through borehole 710 to downhole tools 720. A long length of fiber optic cable 750 can be located at least partially within the ID of set of lower pipe segments 717. Long length of fiber optic cable 750 can include connectors solely at each end, thereby reducing the connectors over this length. The uphole end of long length of fiber optic cable 750 can be connected to first upper pipe segment 716, to light source 740, or to another upper pipe segment. The downhole end of long length of fiber optic cable 750 can be connected via wet connect 730 to downhole tools 720.

In some aspects, wet connect 730 can be part of a housing that also includes a light source 745, similar to the configuration as described for light source 740. When light source 740 is present, light source 745 is typically a reflector and light demodulator to generate the communication signal. In some aspects, light source 745 includes tools, devices, and electronics for implementing the reception of one or more signals, such as one or more of a light detector, a light reflector, an electro-optical transform circuitry, a controller circuitry, an electrical amplifier, a light amplifier, an erbium-doped fiber amplifier, a signal processor, a modulator, a demodulator, a multiplexer, a demultiplexer, an energy source or an input from an energy source, and other components. In other aspects, light source 745 can include a laser, a laser emitting diode, a high-powered LED, or other types of electromagnetic spectrum sources. Wet connect 730 can be coupled to downhole tools 720. Downhole tools 720 can be a BHA, a HF end of pipe assembly, telemetry tools, pumps, sensors, and other tools and devices, or combinations thereof.

Wet connect 730 can be one or more tools or devices in a same or different housing, including, but not limited to, a light detector, a light reflector, an electro-optical transform circuitry, a controller circuitry, an electrical amplifier, a light amplifier, an erbium-doped fiber amplifier, a signal processor, a modulator, a multiplexer, a demultiplexer, an energy source or an input from an energy source, and other components. It also can include devices capable of receiving, transmitting optical and electrical signals, multiplexing and demultiplexing, amplifying, filtering, storing, buffering, triggering and other capabilities typically related to fiber media converters, for example, simple converters, switching converters, network bridges, managed converters, transceivers, gigabit interface converters, fiber-optic communications, small form-factor pluggable transceivers, and other types of converters known within the art of data and power transfer and communications. The data and power can be transferred using data communication protocols including, but not limited to, Ethernet, fast Ethernet, gigabit Ethernet, T1/E1/J1, DS3/E3, as well as multiple cabling types such as coax, twisted pair, multi-mode and single-mode fiber optics and other types of data transfer and power transfer protocols known within the art.

FIG. 8 is an illustration of a flow diagram of an example method 800 for implementing a FOTS. Method 800 can be implemented using, for example, FOTS 700. Method 800 starts at a step 805 and proceeds to a step 810. In step 810, a downhole tool can be lowered into a borehole using a set of lower pipe segments. The length of the lower pipe segments can run into the tens of thousands of feet.

In a step 815, a long length of fiber optic cable can be located within the ID of the set of lower pipe segments. The downhole end of the long length of fiber optic cable can include a wet connect to couple with a wet-mate connector coupled to the downhole tools. Once a coupling has been made, the uphole end of the long length of fiber optic cable can be optically coupled to a first upper pipe segment that includes a fiber optic connector or an electro-optical connector and a pipe cable. Additional upper pipe segments can be added, being mechanically coupled to the respective lower depth pipe segment and communicatively (including power) coupled to the pipe cable which is attached to the OD of the respective upper pipe segments. The first uphole pipe segment and additional uphole pipe segments, if present, can include one or more protectors for the pipe cable to minimize wear of the pipe cable. In some aspects, a light source capable of generating an optical transmission signal can be located at the first upper pipe segment or one of the additional pipe segments. In other aspects, the light source can be located with the surface equipment.

In a step 820, the uppermost of the additional upper pipe segments, or the first upper pipe segment if it is the uppermost, is mechanically coupled to surface equipment, including communicatively coupled to a surface equipment. Surface equipment is further coupled to surface computing systems, capable of generating and receiving data, instructions, information, and telemetry to and from downhole tools and to and from remote locations. In some aspects, surface computing systems are capable of executing a machine learning algorithm or a deep learning neural network. In other aspects, downhole tools are capable of executing a machine learning algorithm or a deep learning neural network.

In a step 825, power can be applied to the light source, at the appropriate location in the system, and high bandwidth unidirectional or bi-directional communications can be established between the downhole tools and the surface equipment and surface computing systems. The appropriate location can be proximate the downhole tools, proximate surface equipment, or proximate the upper pipe segments.

Communications can be one or more, or combination of, but not limited to, data transmissions, amplitude changes, or frequency changes. Communications can utilize optical signals, electromagnetic signals, or other types of energy transfers, for example, thermal energy, radiant energy, chemical energy, nuclear energy, electrical energy, motion energy, sound energy, elastic energy, or gravitational energy. In some aspects, communications, as used herein, are not limited to the transfer of information; communications can include the transfer of one or more types of energy to perform work (e.g., adjusting a valve, activating a motor, energizing another system, or performing other types of work) or to effect a change of state (e.g., a binary switch or variable, a position indicator, a programmed variable, a conditional variable, or other types of state changes). In some aspects, additional steps can be included, for example, adding a step after step 815 to verify the communication and power coupling prior to proceeding with step 820. Method 800 ends at a step 850.

Since fiber optic has a higher bandwidth than electrical wires—especially over long distances (30-feet to 3,000-feet or more) there can be an advantage of having more than one electrical wire connected to the top and bottom ends of the long fiber optic cable. For example, 10 different BHA sensors can feed electrical signals into a downhole light source/transceiver combination. The 10 electrical signals can be combined and transmitted by the fiber optic light source. The fiber optic receiver can receive the signal from downhole, split the signals into several different signals, in this example, 10, and then transmit the different signals uphole to the surface equipment.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. The terms “comprises” and “comprising” should also be interpreted as referring to elements, components, or steps in a non-exclusive manner, indicating that a referenced element, component, or step may be present, or utilized, or combined with other elements, components, or steps that are expressly referenced. Likewise, the terms “comprises” and “comprising” should also be interpreted as referring to elements, components, or steps in an exclusive manner, indicating that a referenced element, component, or step may be present, utilized separately, independently, together but independently, or together dependently or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

The disclosure provides different aspects including a system, an apparatus and a method. Each of aspects can have one or more of the additional elements corresponding to the below dependent claims in combination.

What is claimed is:

1. A system, comprising:
a set of lower pipe segments, capable of coupling to downhole tools;
a lower distal end of a long length of fiber optic cable, capable of utilizing a wet connect to connect to the downhole tools, wherein the long length of fiber optic cable is positioned after the downhole tools are located below a surface, and wherein the long length of fiber optic cable is communicatively coupled to the downhole tools;
a set of upper pipe segments, capable of mechanically coupling the set of lower pipe segments and a surface equipment, wherein the set of upper pipe segments includes at least one upper pipe segment; and
an upper distal end of the long length of fiber optic cable, located uphole from the lower distal end, capable of utilizing an uphole connector to communicatively connect to a pipe cable of a first upper pipe segment in the set of upper pipe segments, and wherein each upper pipe segment in the set of upper pipe segments includes a respective pipe cable communicatively coupled to neighboring pipe cables, and where a collection including each pipe cable enables a communications coupling between the long length of fiber optic cable and the surface equipment.

2. The system as recited in claim 1, further comprising:
one or more pipe cable protectors, capable of protecting the pipe cable, and attached to one or more upper pipe segments in the set of upper pipe segments, wherein the pipe cable protectors rotate with a respective of the upper pipe segments and are one or more of a cage and centralizer, and utilize one or more of a collar, stop collar, or clamp.

3. The system as recited in claim 1, wherein the uphole connector is a first uphole connector and the wet connect is a first wet connect, further comprising:
a lower distal end of an electrical cable capable of transmitting electrical energy and communication signals, coupled to the downhole tools utilizing a second wet connect; and
an upper distal end of the electrical cable, located at a second uphole location from the lower distal end of the electrical cable, capable of utilizing a second uphole connector to connect to an electrical pipe cable attached to the first upper pipe segment, wherein the electrical pipe cable electrically couples to the surface equipment.

4. The system as recited in claim 1, further comprising
a light source, capable of generating or modulating a signal transmitted through the long length of fiber optic cable, wherein the light source is one of a laser or light emitting diode.

5. The system as recited in claim 4, wherein the light source is located at one of proximate the wet connect or proximate the uphole connector.

6. The system as recited in claim 1, wherein the pipe cable comprises one of the electrical pipe cable, an electrical wire, or a fiber optic cable.

7. The system as recited in claim 1, wherein the wet connect utilizes at least one of one or more electrical wet connects, or one or more fiber optic wet connects.

8. The system as recited in claim 1, wherein the wet connects provides for one or more of an electrical transmission or a communication transmission.

9. The system as recited in claim 1, wherein the downhole tools are one or more of a bottom hole assembly, telemetry tools, logging while drilling tools, measuring while drilling tools, seismic while drilling tools, sensors, valves, actuators, data collection tools, and wireline tools.

10. The system as recited in claim 1, wherein the long length of fiber optic cable is one of a fiber optic cable, a reinforced fiber optic cable, a supported fiber optic cable, or an armored fiber optic cable.

11. The system as recited in claim 1, wherein the long length of fiber optic cable is one or more of a fiber optic cable and one or more of a long length of electrical cable.

12. The system as recited in claim 1, wherein the uphole connector utilizes one of an electro-optical connector or an optical-optical connector, and where the uphole connector supports the long length of fiber optic cable when coupled with the wet connect.

13. The system as recited in claim 1, wherein the set of upper pipe segments includes at least one upper pipe stand.

14. An apparatus, comprising:
a long length of fiber optic cable located within a borehole;
a downhole tool, communicatively coupled to a lower distal end of the long length of fiber optic cable, wherein the downhole tool utilizes a wet connect;
a set of pipe segments, where each pipe segment is mechanically coupled to a neighboring pipe segment, and wherein a first upper pipe segment in the set of pipe segments is coupled to an upper distal end of the long length of fiber optic cable, and the first upper pipe segment is located uphole from the downhole tool; and
surface equipment coupled to the set of pipe segments.

15. The apparatus as recited in claim 14, further comprising:
a light source, capable of generating or modulating an optical signal and transmitting the optical signal through the long length of fiber optic cable.

16. The apparatus as recited in claim 15, wherein the light source is located proximate the downhole tool, proximate the first upper pipe segment, or proximate the surface equipment, and the light source is one of a laser or light emitting diode.

17. The apparatus as recited in claim 14, wherein the surface equipment is one or more of a derrick, a drilling system, a computing system, an electrical system, and a power source.

18. The apparatus as recited in claim 14, wherein an upper portion of the set of pipe segments utilizes one or more of a cage or a centralizer to protect one or more of a pipe cable attached to each of the respective pipe segments in the set of pipe segments, wherein the pipe cable communicatively couples the long length of fiber optic cable and the surface equipment.

19. The apparatus as recited in claim 14, wherein each of the pipe segments in the set of pipe segments utilizes a pipe cable to communicatively couple and power couple a neighboring pipe segment and wherein the pipe cable is one of a fiber optic cable, an electrical cable, or an electrical wire.

20. A method, comprising:
connecting a downhole tool to a set of lower pipe segments and lowering the downhole tool below a surface using the set of lower pipe segments;
coupling an uphole portion of the set of lower pipe segments to a first uphole pipe segment, wherein a lower distal end of a long length of fiber optic cable is lowered within an internal diameter of the set of lower pipe segments and communicatively coupled to the downhole tool, and an upper distal end of the long length of fiber optic cable coupled to the first uphole pipe segment;
linking an uppermost upper pipe segment in a set of upper pipe segments to a surface equipment, wherein the set of upper pipe segments includes the first uphole pipe segment and zero or more additional upper pipe segments, and wherein each upper pipe segment in the set of upper pipe segments includes a pipe cable to communicatively couple the long length of fiber optic cable with the surface equipment; and
enabling communications between the surface equipment and the downhole tool using the long length of fiber optic cable and the one or more pipe cables.

21. The method as recited in claim 20, wherein a light source is located at one of proximate the downhole tool, proximate the surface equipment, or proximate the first uphole pipe segment, where the light source generates or modulates an optical signal for communicating through the long length of fiber optic cable and the one or more pipe cables.

22. The method as recited in claim 20, wherein the pipe cable is at least one of one or more of a fiber optic cable, one or more of an electrical cable, or one or more of an electrical wire.

23. The method as recited in claim 20, wherein the set of upper pipe segments utilizes a cable protector, where the cable protector rotates in tandem with the set of upper pipe segments, and is one of a cage, a centralizer, a collar, or a clamp.
